(19) United States
(12) Patent Application Publication
(10) Pub. No.: US 2005/0251865 A1
(43) Pub. Date: Nov. 10, 2005

(54) Data privacy management system and method

(76) Inventors: Marco Casassa Mont, Bristol (GB); Siani Lynne Pearson, Whitebrook Llanvaches (GB); Peter Joseph Bramhall, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/972,144

(22) Filed: Oct. 25, 2004

(30) Foreign Application Priority Data
May 7, 2004 (GB) 0410180.4

(51) Int. Cl. H04L 9/00; H04L 9/32; G06F 11/30; G06F 12/14

(52) U.S. Cl. 726/26

(57) ABSTRACT

A data privacy management system includes a data repository, a private data mediating system and a privacy manager. The data repository stores private data items in an obfuscated form. Each private data item has associated privacy policy data a defining conditions to be met to ensure the privacy of the data item. A private data mediating system communicates with the privacy manager to obtain de-obfuscated private data items that are extracted from the data repository 10. De-obfuscation of the data 51, 53 is subject to satisfaction of the privacy manager that the respective conditions ensuring privacy of the data item are met.

### FIELD OF THE INVENTION

The present invention relates to a system and method for privacy management of confidential and/or sensitive data.

### BACKGROUND OF THE INVENTION

Organizations store large amounts of confidential data about their employees, customers and partners. On the one hand, accessing and managing this data is fundamental for their business: confidential information is retrieved, analysed and exchanged between people (and applications) that have different roles within an organization (or across organizations) to enable the provision of services and transactions. On the other hand, data protection and privacy laws dictate increasingly strict constraints about how this data has to be protected, accessed and managed. Failure to comply with such privacy laws can have serious legal and business consequences. The reputation and brand of organizations that do not provide sufficient privacy protection for its data is likely to be negatively affected which in turn would have negative financial impacts. As discussed above, it is fundamental for an organization to use such sensitive data. However, this must be done in a way that is legally compliant.

Current data repositories, such as databases, typically include limited forms of access control mechanisms but offer little or no privacy management. For example, a database may offer user accounts so that access control policies can be implemented. The policies define actions the user associated with a respective account can perform in respect of the data repository. A normal user (typically a clerical employee) may be able to access, add and amend records but an administrator (for example a supervisor or IT technician) may be the only user permitted to delete records or change the structure of the database. In other cases, certain users may be given read only access to prevent unauthorised changes to data.

However, privacy management is not just a matter of authentication and authorization. When dealing with confidential (particularly personal) data, among other things, it is necessary to capture the purpose of data, convey the consensus of the data owners regarding acceptable use of their data and make decisions on access requests based on the requestors' intentions.

Privacy management is usually achieved using a privacy policy. In addition to the above requirements, privacy policies can dictate additional terms and conditions under which access to confidential data can be granted: this involves the satisfaction of constraints and obligations which might require the processing of credentials, trust verification and management of contextual information.

Organizations are responding to data privacy requirements by implementing privacy policies dictating how data can be used within the respective organization. However, most data repositories cannot intrinsically support these policies. Once data has been obtained from a repository by a user with credentials to satisfy the repository's access control system, the data can be used (or abused) however the user wishes.

Due to these limitations in data repositories, organizations have been forced to implement their policies at a personnel level, requiring their employees and management to be aware of, adhere to, and enforce the policy's requirements. Such implementations require an employee to be conscious of the policy when performing his or her duties and only perform an action if it is in accordance with the policy. Whilst some jobs can be changed to take policies into account, an employee typically has many policies, duties and other responsibilities to take into account in a typical day, some of which conflict leading to uncertainty and breach of policy.

In large organizations, people have different roles and skills. Business tasks are achieved thanks to collaboration among these people. The rigid enforcement of privacy policies might create disruptions in business practices and introduce unacceptable burdens. For example, confidential data can be stored in a variety of data repositories. In some cases, only technical specialists might have the right skills to retrieve data in a way that is meaningful for business people, marketing departments or strategists. Unfortunately, privacy policy constraints might dictate that these technical people must not access confidential data: in this case they would not be able to provide a service to the business people. As the business people themselves may not be able to retrieve meaningful data, time is likely to be lost and in extreme cases, adherence to the policies may prevent potentially lucrative uses of data. Similar observations apply for applications and services run by different organizations within an enterprise.

In an attempt to address data privacy within organizations, various computer systems for privacy management have been suggested. Most systems address data privacy purely from an access control perspective. This is inadequate because privacy is not just a matter of authorization, as additional aspects need to be taken in account such as trust management and dealing with ongoing privacy obligations dictated by legislation and an organization's guidelines.

Other systems attempt to implement privacy management by replacing a data repository with one that supports data access in dependence on an associated policy. Such policies are implemented at a system level, preventing a user from inadvertently overriding it. Such systems normally require rewriting of the data repository so that data can only be accessed via a specific driver or interface that supports and implements the respective policies. This is a very intrusive and expensive approach and can also be problematic for organizations having other applications that interface with the data repository as these must then be rewritten to communicate via the driver/interface. One example of this approach is the hippocratic database. In a hippocratic database, mechanisms are provided for preserving the privacy of the data by associating privacy metadata (i.e. privacy policies) with data stored in data repositories. Privacy metadata is added via additional database tables. Modified Java Database Connectivity (JDBC) data adaptors are used that deal with this privacy metadata and interact with external privacy engines. This approach requires customers to buy new versions of databases. In addition, it does not take into account that the management of privacy spans across database boundaries: such management has to be carried out within a broader context as it encompasses aspects such as the management of organization-wide privacy policies, obligations and application/service-based privacy policies.

Some systems, such as translucent databases, use data encryption to restrict access to confidential data when it is stored in data repositories. Most of these systems focus on the “confidentiality” and access control aspects: they commonly have little flexibility in providing policy-driven mechanisms encompassing aspects beyond authentication and authorization such as dealing with data purpose, matching the requesters' intentions against this purpose, enforcing obligations, etc.

Additional work has been carried out for privacy management in the area of data mining and statistical databases. In this context, the main goal is to prevent privacy violations when using data mining learning algorithms, data correlations and linking techniques. Current privacy management techniques in data mining use statistical approaches (i.e. information is not returned as it is but i is statistically modified, for example to reflect average values) and knowledge hiding.

### STATEMENT OF THE INVENTION

According to a first aspect of the present invention, there is provided a data privacy management system comprising a data repository, a private data mediating system and a privacy manager,
the data repository storing private data items in an obfuscated form, each private data item having associated privacy policy data defining conditions to be met to ensure the privacy of the data item;
the private data mediating system being arranged to communicate with the privacy manager for obtaining de-obfuscated private data items extracted from the data repository;
wherein de-obfuscation of the data is subject to satisfaction of the privacy manager that the respective conditions ensuring privacy of the data item are met.

According to another aspect of the present invention, there is provided a database system for managing data privacy comprising a database, a database application protocol interface and a data management system;
the database including obfuscated private data items stored with privacy policy data associated with conditions to ensure the privacy of the data item;
the database application protocol interface including computer readable program code means for
   extracting privacy policy data with any obfuscated private data items extracted from the database;
   obtaining data required by said privacy policy for disclosure of an extracted private data item; and,
   communicating said obtained data and said extracted privacy policy data to the data management system to de-obfuscate extracted private data items;
wherein, upon receipt of said obtained data and said extracted privacy policy, the data management system is arranged to provide data for de-obfuscating the obfuscated private data item if the respective conditions associated with the privacy policy data are met by the obtained data.

According to another aspect of the present invention, there is provided a data structure including a plurality of obfuscated private data items and privacy policy data associated with each obfuscated private data item, the privacy policy data being associated with conditions to be met-to for disclosure-of the private data item in a de-obfuscated form, wherein upon the conditions being met, the data structure being arranged to store the private data item in the de-obfuscated form for onward communication, the private data items being selectively de-obfuscated upon the respective conditions being met enabling onward communication of the data structure including obfuscated and de-obfuscated data items.

According to another aspect of the present invention, there is provided a method of managing privacy of a data item comprising:
associating privacy policy data with the data item, the privacy policy data defining conditions to be met to ensure privacy of the data item;
obfuscating the data item;
storing the obfuscated data item and privacy policy data in a data repository;
accepting a request by a requestor to de-obfuscate the obfuscated data item obtained from the data repository, the request including the privacy policy data; and,
transmitting data for de-obfuscating the obfuscated data item to the requestor if the conditions defined by the privacy policy data are met.

According to another aspect of the present invention, there is provided a computer readable medium having computer readable code means embodied therein for managing privacy of data items and comprising:
computer readable code means for associating privacy policy data with a data item, the privacy policy data defining conditions to be met to ensure privacy of the data item;
computer readable code means for obfuscating the data item;
computer readable code means for storing the obfuscated data item and privacy policy data in a data repository;
computer readable code means for accepting a request by a requestor to de-obfuscate the obfuscated data item obtained from the data repository, the request including the privacy policy data; and,
computer readable code means for transmitting data for de-obfuscating the obfuscated data item to the requestor if the conditions defined by the privacy policy data are met.

According to another aspect of the present invention, there is provided a data privacy management system comprising a data repository, a private data mediating system and a privacy manager;
the data repository storing private data items in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met.

According to another aspect of the present invention, there is provided a data privacy management system comprising a data repository, a further data repository, a private data mediating system and a privacy manager;
the data repository storing private data items in a hashed form, each private data item having associated privacy policy data defining conditions to be met to ensure the privacy of the data item;
the private data mediating system being arranged to communicate with the privacy manager for obtaining non-hashed private data items extracted from the data repository;
the further data repository storing private data items in a non-hashed form, data from said further data repository being accessible subject to satisfaction of the privacy manager that the respective conditions ensuring privacy of the data item are met.

According to another aspect of the present invention, there is provided a data privacy management system comprising a data repository, a private data mediating system and a privacy manager;
the data repository storing private data Hems in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met, the private data mediating system being arranged to generate a data file storing one or more selected de-obfuscated private date items and/or obfuscated private data items for onward transmission.

According to another aspect of the present invention, there is provided a data privacy management system comprising a data repository, a private data mediating system, a data gateway and a privacy manager,
the data repository storing private data items in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met, the data gateway being arranged to identify de-obfuscated private data items extracted from said repository and permit passage of said private data items through the data gateway upon satisfaction of the privacy manager that the respective conditions ensuring privacy of the data item are met.

In the context of the present invention, the term “obfuscated data” refers to data that is rendered unintelligible whilst “de-obfuscated data” refers to intelligible data (typically the original data). Examples of obfuscation processes include encryption, hashing, and reversible compression. A reversible compression algorithm may convert of data blocks to numbers or other codes. Reversing the compression would operate in reverse to the encoding process.

Data subject to privacy management controls is referred to as private data. It will be appreciated that this may include confidential data, personal data, sensitive data, data regulated by legislation or any other form of data subject to privacy control.

The present invention seeks to provide a system for privacy management of private data stored by organizations and other organizations. Data is stored in standard data repositories in such a way that sensitive or confidential items of data (referred to as private data) is obfuscated and associated with a privacy policy. Data structures containing private data can be extracted from the data repository and sent to other entities with the private data remaining obfuscated. Entities that try to access the obfuscated private data can be different from those entities that retrieve the private data items from the repository. Obfuscated data can be accessed via a private data mediating system that is arranged to communicate with a privacy manager which in turn is arranged to decide what is visible at a given time for each specific request for content. The visibility of (and in some embodiments, access to) the obfuscated data is adaptive, depending on the requester, the context and purpose. Hence multiple “views” on a data structure can be provided by our system.

The present invention seeks to provide a system in which privacy management and control is transparent to users and to the data repository itself. In this manner, the present invention can be used with existing data repositories and does not necessarily interfere with other applications accessing non-private data within the repository.

In embodiments of the present invention, privacy management policies can be applied to records or fields at any one of a number of levels of granularity. This means that different users or user roles can be provided with different levels of access permissions for different types of data within the repository. Privacy control is preferably implemented by obfuscation of private data fields and/or whole data records. De-obfuscation is subject to successful authorisation by the privacy manager.

In this manner, adaptive access to confidential information can be provided based on the satisfaction of privacy policies with a minimal impact on data repositories in terms of required technological changes. Little disruption and additional cost is experienced by the organization deploying the system.

In one embodiment of the present invention, an interface in the form of a private data mediating system is used by people and applications to access obfuscated data and mediates their interactions with data repositories as dictated by privacy policies; one or more Privacy managers (i.e. trust services run by organizations or trusted third parties) deals with the enforcement of privacy policies. The process of disclosing private data is adaptive to contextual information.

The present invention seeks to allow existing data repository technologies to be utilized whilst minimizing the impact on the data repositories and the organizations themselves. Interaction with data repositories can still happen as usual but with the additional guarantee that private data is now protected and contextually released, in a fine-grained way, based on the fulfillment of associated privacy policies.

Whilst implementing a system according to an embodiment of the present invention may require some changes in the logical definition of data structures of the data repository (i.e. different types of fields in tables, different LDAP classes' definitions, etc.) in order to store obfuscated data and the associated privacy policies, no technological changes are required for data repositories or the access/query language used.

In embodiments of the present invention, fine-grained privacy policies can be associated with individual data fields or items, forcing requesters to be compliant to these policies if they want to view the associated data. This can be achieved in a flexible way, without a priori preventing the various entities from interacting, as dictated by business processes.

### BRIEF DESCRIPTION OF THE DRAWINGS

FIG. 1 is a schematic diagram of data repository and an application program interface for accessing data stored by the data repository;

FIG. 2 is a schematic diagram of a table from a data repository storing private data fields according to an embodiment of the present invention;

FIG. 3 is a schematic diagram of a data privacy management system according to an embodiment of the present invention;

FIG. 4a is a schematic diagram of a record of data fields prior to implementation of a data privacy management system according to an embodiment of the present invention;

FIG. 4b is a schematic diagram of the record of data fields of FIG. 4a after implementation of an embodiment of the present invention;

FIGS. 5a and 5b are views of a table of data including private data fields provided to users with different credentials by an embodiment of the present invention;

FIG. 6 is a schematic diagram of an alternate embodiment of the present invention;

FIG. 7 is a schematic diagram illustrating selected aspects of the embodiments of FIGS. 3 and 6 in more detail;

FIG. 8 is a schematic diagram illustrating data flow in an embodiment of the present invention; and,

FIGS. 9a and 9b are flow charts illustrating aspects of a method according to an embodiment of the present invention.

### DETAILED DESCRIPTION

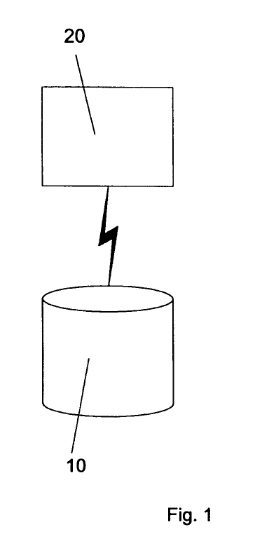

FIG. 1 is a schematic diagram of a data repository 10 and an application program interface 20 for accessing data stored by the data repository 10.

A data repository 10 stores data, at least some of which is private data, that is, data considered sensitive and/or confidential and is the subject of privacy control. The data repository 10 is a standard structured query language (SQL) relational database storing data in linked tables of records. Data stored by the data repository 10 can be accessed in a conventional manner, for example using an open database connectivity (ODBC) application program interface (API) or a Java database connectivity (JDBC) API 20.

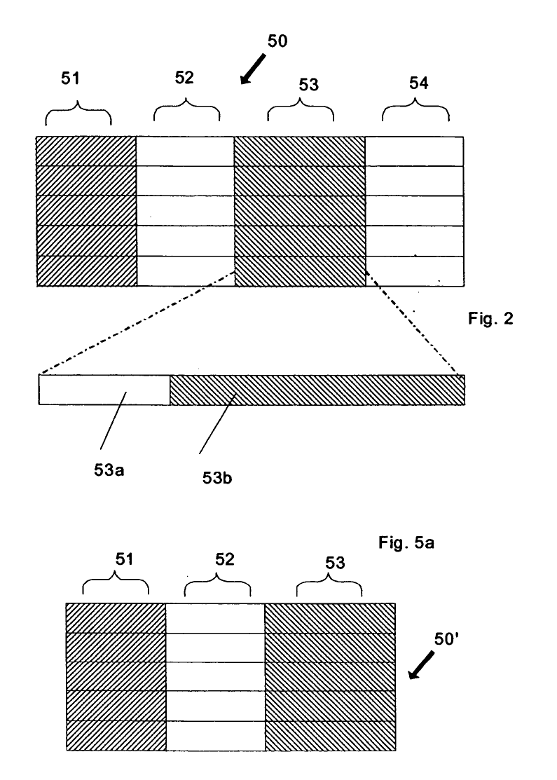

FIG. 2 is a schematic diagram of a table of records 50 of a data repository 10 including private data according to an embodiment of the present invention.

The table 50 is formed from a number of data fields 51-54 (shown as columns). Records are illustrated as rows 50a-50e, each row 50a-50e having an entry in a respective data field 51-54. The first and third data fields 51, 53 hold private data whilst the remaining fields 52, 54 hold non-private data. Data in non-private data fields 52, 54 is stored in a non-obfuscated (clear) form that can be read by anyone having the access rights to access the table. Data in private data fields 51, 53 is stored in an obfuscated form. A user having access rights to access the table is able to access the private data fields, the content is not intelligible as it is obfuscated.

An example of an obfuscated data field is shown in FIG. 2 which includes a policy sub-field 53a and an obfuscated data sub-field 53b. The policy sub-field includes a definition of the privacy policy that applies to the data.

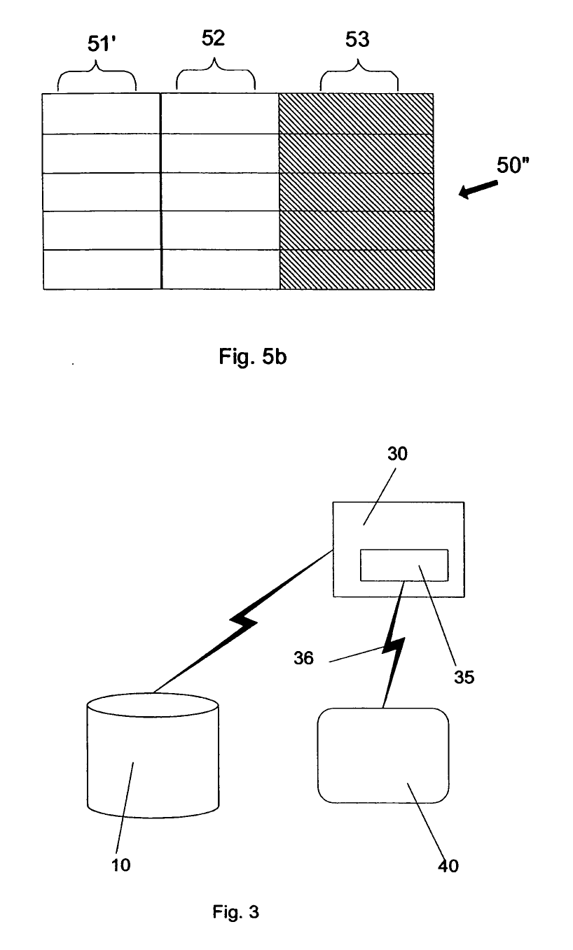

FIG. 3 is a schematic diagram of a data privacy management system according to an embodiment of the present invention.

The data privacy management system includes an interface 30 and a privacy manager 40. The interface 30 includes a private data mediating system 35.

The private data mediating system 35 mediates interactions between the interface 30, the data repository 10 and the privacy manager 40. When private data is retrieved from the repository 10, the private data mediating system 35 can automatically attempt to de-obfuscate the private data. Alternatively, de-obfuscation can be requested by a user, either in reply to a prompt when the private data mediating system 35 detects retrieval of private data or alternatively via an appropriate user interface control.

When attempting to de-obfuscate data, the private data mediating system 35 extracts policy data from the policy sub-field 53a of the private data field and obtains contextual data required by the policy defined by the policy data. The private data mediating system 35 then establishes a secure communication link 36 to the privacy manager 40 and transmits the policy data and the obtained contextual data to the privacy manager 40.

Upon receipt of the policy data and contextual data, the privacy manager 40 determines whether the contextual data satisfies the policy defined by the policy data. If the policy is satisfied then the privacy manager 40 transmits de-obfuscation data via the secure communication link 36 to the private data mediating system 35 allowing it to de-obfuscate the data.

The decision made by the privacy manager 40 of whether to allow access to private data by an entity at a specific point in time takes into account the specific request, relevant privacy policies, intended use of the data and requestor's credentials.

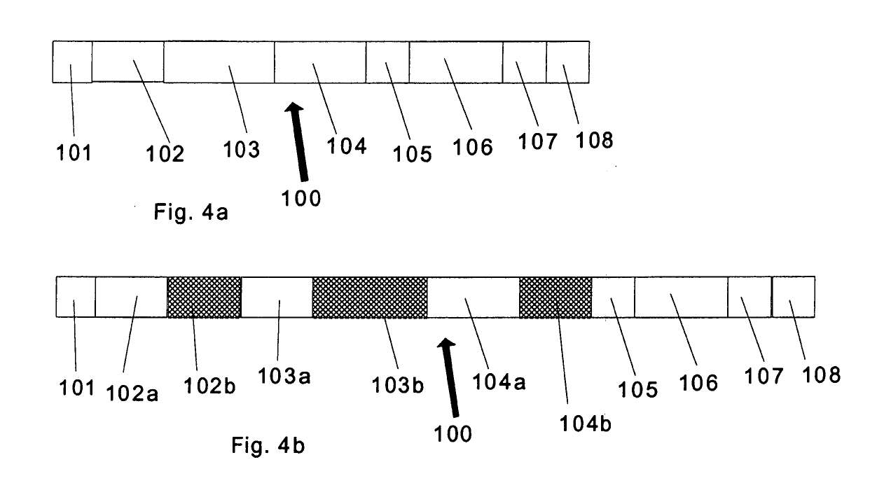

An example application for an embodiment of the present invention is shown in the schematic diagram of FIGS. 4a and 4b

In this example, an airline maintains data on its customers in a customer table of its database. Prior to implementation of an embodiment of the present invention, each record 100 in the customer table had a format as shown in FIG. 4a. Each record included fields for
a unique (internal) customer ID 101;
customer name 102;
customer address 103;
customer credit card number 104;
customer country 105;
customer flight preferences 106;
customer data usage preferences 107; and,
customer sex 108.

The airline decides to implement a privacy policy that restricts viewing of the customer name field 102, customer address field 103 and credit card number field 104. A selection of the requirements defined by the policy includes:
all fields are to be viewable by members of the customer service department;
allowing the credit card number to be readable only by accredited personnel or systems within its accounts department; and,
allowing the name and address fields 102, 103 to be readable by advertising department only if approved in the customer's data usage preferences 107.

During implementation of a system according to an embodiment of the present invention, the structure of the customer table 100 is not changed. Thus, any reports, SQL queries or the like that have been written for use with the database are not affected. During implementation, data in the data fields selected to be private (102, 103, 104) is replaced with an obfuscated version (102b, 103b, 104b) of the data preceded by policy data (102a, 103a, 104a) defining the criteria that must be satisfied to view the respective data, as is shown in FIG. 4b.

A basic form of privacy policy would consist of text describing a list of conditions and constraints (strings of characters). An example policy for the address field 103 could be:
access granted if requestor.department={customer-service} or if (requestor.department={advertising} and data_usage=“Y”)

The policy data preceding the obfuscated data (102b, 103b, 104b) may be the text of the policy itself, a link, such as a URL, to the policy text or an encoded version of the policy or some other value via which the private data mediating system can obtain the policy criteria (or at least details of data required for submission to the privacy manager to determine whether the policy is satisfied). The privacy manager or some other central entity may store the policy details.

Thus, when a member of the advertising department wishes to run a mail merge, she runs the SQL query:
select*from customer_table where customer_country=“uk” (1)

All data fields would be returned for those entries having a customer country “uk” but the credit card field 104 would be obfuscated (with no possibility of a member of the advertising department being able to de-obfuscate it) and the name and address fields 102, 103 would only be de-obfuscated if the respective data usage field 107 permitted.

If the airline decided to restructure its database in the future (for example moving the credit card number field 104 to a separate table indexed by unique customer ID 101, no change to the data privacy system would be needed.

Other scenarios where embodiments of the present invention may be applicable include:
Organization: an organization collects private data about employees, customers, partners, etc. People (or applications/services), with different roles and objectives might need to access this confidential information. Roles played by people include IT technicians, researchers, marketing people, project managers and HR people. The kind of confidential information they can access must depend on their role, their declared intent, purpose of the stored data, organization policies, legislation and specific customers' (opt-in and opt-out) policies;
Federated Identity Management: Confidential information can be sent from a service provider A to a service provider B in the context of multi-party electronic interactions driven by a transaction. Depending on who initiated the transaction (customer, service provider, etc.), the purpose of data and also customers' policies, a subset only of the whole data may be accessed and sent to the other parties, as dictated by privacy policies. For example policy constraints could dictate that specific portions of private data cannot be sent outside an organization for marketing reasons or that it can only be sent to a predefined set of organizations to enable customers' transactions.
Healthcare: it is important to have access control on a patient's medical record. Administrative staff, doctors, nurses, lab technicians, insurance providers, and researchers may have access to some but not necessarily all of a patient's information. Access to information depends on the purpose of data, the intention of the entity trying to access this data and the satisfaction of any specific fine-grained patient's preferences.

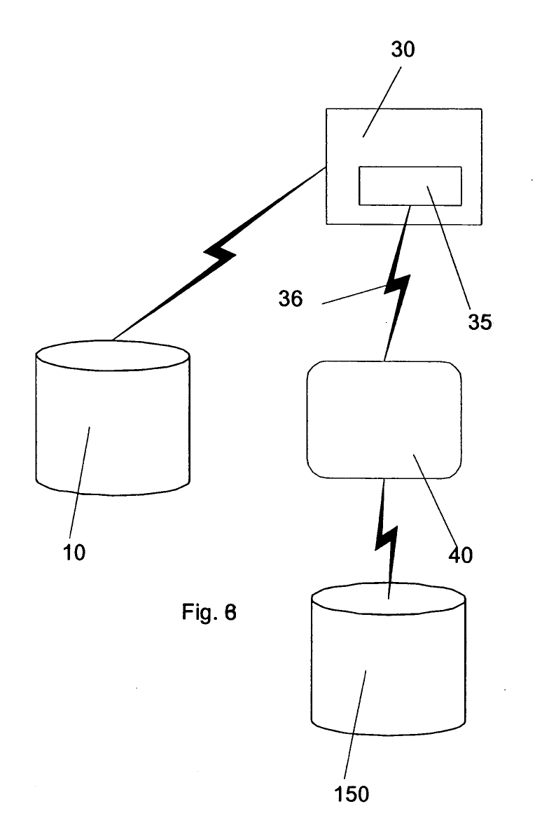

FIGS. 5a and 5b show an example where different “views” of private data are provided to different requestors. Private data can be retrieved by people and applications that have no rights to access its content (i.e. they do not satisfy privacy policies) but are in charge of querying data repositories on behalf of other people, as is shown in FIG. 5a: in this case the content is not de-obfuscated. Nevertheless, the obfuscated data can be sent to other entities that can access their content if they satisfy the associated privacy policies. In the example of FIG. 5b, the receiving entity is permitted to de-obfuscate private data fields 51 (shown in a de-obfuscated form 51′) but not private data fields 53.

This basic model can be extended and adapted to a variety of scenarios including intra-organizational and inter-organizational contexts. In particular the privacy manager can be provided by an organization for internal consumption or by one or more external trusted third parties, to enable multi-party interactions and at the same time increase the overall trust and accountability.

The content of an obfuscated field (for example in a database record) could be represented as:
<privacy policy, Encryption(privacy policy data), Encryption(private data)>

If public key encryption is used, the privacy manager provides its public key to users. When obfuscating data, a symmetric key is generated and used to encrypt the data. The symmetric key and a hash value of the associated policies are encrypted as the privacy policy data in a package by using the public key. The overall information (encrypted private data, clear text policies and encrypted privacy policy data) is stored as the obfuscated field in the repository. The privacy manager is the only entity that can decrypt the above encrypted privacy policy data package. The hash contained in the package is used to check for the integrity of the associated policies. Once integrity has been ascertained, the policies can be checked for compliance and allowing disclosure of the symmetric key.

An alternative approach to obfuscation could use identifier-based encryption (IBE). Any kind of string (including text, pictures, terms and conditions, etc.) can be used as an IBE encryption key. Privacy policies are preferably used for this purpose. The correspondent IBE decryption key can only be generated by the privacy manager as it is the only entity that has the “secret” necessary for doing it. The privacy manager checks the compliance of a requestor with these policies. The generation of IBE decryption keys can be postponed in time i.e. until they are actually necessary for decryption purposes. Any tampering with the IBE encryption key will make impossible for the correct decryption key to be generated. In this situation, only the privacy policy data (which is itself the IBE encryption key) needs to be stored with the obfuscated private data. No encrypted private policy data is stored. To obtain de-obfuscation data, the privacy policy data and obtained contextual data is sent to the privacy manager. If the contextual data satisfies the policy defined by the privacy policy data then the privacy manager generates a decryption key from the privacy policy data and transmits this to the private data mediating system for use in de-obfuscating (decrypting) the obfuscated private data. If the privacy policy data has been in any way altered or tampered with, the decryption key generated will not be appropriate for decrypting the obfuscated private data, thereby ensuring integrity of the privacy policy data.

As the policy data may be quite large, IBE encryption of the private data may prove too computationally intensive, in which case a combination of PKE and IBE could also be used. In this embodiment, the obfuscated data includes:
<privacy policy, Encryption(privacy policy data), Encryption(private data)>

As before, the privacy policy is in a clear readable from. The encrypted privacy policy data contains a symmetric key used to encrypt the private data and a hash of the privacy policy data. The difference to the above described embodiment is that the privacy policy data is encrypted using the privacy policy as an IBE encryption key. The hash need not be included in the encrypted policy data if storage space is at a premium as the IBE encryption ensures the integrity of the policy data.

It will be appreciated that other obfuscation mechanisms could be substituted in place of that discussed above. For example, instead of encryption, reversible compression, encoding, hashing or some other one way or two way obfuscation mechanism could be used.

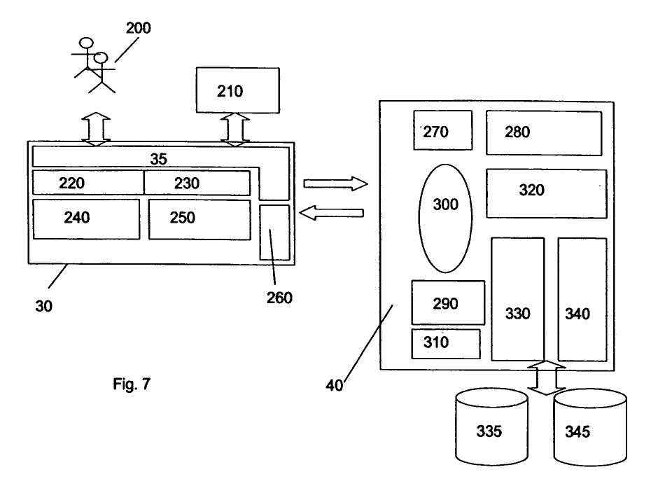

In the case of hashing, a separate database of non-hashed data could be made accessible only by the privacy manager. An alternative embodiment of the present invention using hashing for obfuscation is illustrated in FIG. 6.

Data within private data fields of a data repository 10 is hashed and associated with a respective privacy policy, as discussed above with reference to FIGS. 2 and 3. However, upon presentation of a policy (and credentials etc. that satisfy that policy) from a private data mediating system 35, the privacy manager 40 accesses a separate database 150, obtains the corresponding un-hashed data and transmits this across the secure communications link 36 to the private data mediating system 35. To ensure that the policy has not been tampered with (for example a condition could have been added so that the requestor satisfies the policy), it is preferable that the hash is generated in dependence on the policy and the hash is provided to the privacy manager to allow a new hash to be produced in dependence on the policy and compared to the hash provided. Such an implementation requires that any updates to private data are written to two repositories as opposed to one but it means that a brute force or other attack against encrypted data obtained from the main data repository 10 is extremely difficult.

In cases where obfuscation is by encoding or reversible compression, the same encoding/compression scheme is likely to be used for obfuscating more than one data item. It is therefore not desirable to disclose the encoding/compression scheme to a private data mediating system/user. In such a case, an implementation such as discussed above with reference to FIG. 6 could be used with the privacy manager providing the de-obfuscated data itself as opposed to data for use in de-obfuscating the obfuscated data.

The specific format used to represent privacy policies could be changed depending on the particular implementation. However, the format used to represent a policy should be flexible enough to express the following aspects:
privacy: policies define conditions and constraints on how data must be handled, disclosed to other parties, protected, etc:
authorization: policies dictate who can access what and under which conditions;
obligation: policies define the constraints that need to be fulfilled potentially over a long period of time (in case of data retention or data deletion policies);
preferences: policies define customers' preferences when multiple choices are available, for example in the way confidential information must be handled, disclosed or used;
trust: policies dictate trust requirements to be satisfied by the involved parties;
control: policies allow people to be involved in the management and monitoring of their data for example by explicitly asking to be notified each time their data is disclosed.

Examples of policies follow below. They reflect a user's perspective and they are related to a scenario where customers' data is stored and accessed by members' of an organization. Policies from an organization's or employer's point of view could also be envisaged:
Entities can access my data subordinate to the fact that their intent matches the “e-commerce transaction” purpose;
Do not disclose any of my personal details to entities with identities X, Y, Z;
Allow the access of this data only when dealing with entity W;
Notify me via e-mail, every time you use some of my identity information;
Ask for my authorization (via a predefined communication channel) every time you need to disclose this attribute to a third party;
Interact with this trusted third party and state your intentions in order to obtain the current values of these attributes. You will be audited.

The above policies reflect customers' constraints and (for simplicity) they are expressed in natural language. Notice that constraints might require the fulfillment of actions involving the data owners, such as notifications or explicit requests for authorization. Different kind of policies can be used to express internal organization guidelines and privacy requirements.

Preferably, privacy policies are written in a formal language (via logical expressions and constraints) in a way that they can be programmatically interpreted. However, the implementation of policies and their format can be varied as is needed. Note that the policy data stored with the obfuscated data could be an encoded or compressed version of the actual policy. For example, the privacy manager may include a repository linking codes to actual policies. Similarly, the policy data may be a pointer to the actual policy stored elsewhere. In each case, the policies could be updated without needing to update the obfuscated data in the data repository 10. Where the actual policy is not discernible by the private data mediating system, an initial query would have to be made to a policy management system, which may be the privacy manager 40 or another entity responsible for maintaining the policy repository to determine the credentials etc needed for submission to the privacy manager 40 to obtain the de-obfuscation data.

Preferably, privacy policy data should stick with the encrypted data and this link should not be able to be broken. In preferred embodiments of the present invention, the stickiness of policies to identity information is obtained by obfuscating the identity information in a way that its de-obfuscation is a “function of” the associated policies. Any tampering with the policy data prevents the de-obfuscation of data.

Once retrieved, private data can be stored and/or represented via data structures that simplify their portability in case of their transmission. Such a data structure would contain any retrieved confidential information along with the associated privacy policies. One implementation of such a data structure would be in XML. A portion of an example XML data structure including a header section and a record section representing an example record extracted as the result of the SQL query (1) discussed above with reference to FIG. 4b is shown below.

<extracteddata>

<provacymanager>125.18.219.66</privacymanager>
<mediator>www.policysite.org/mediator.jar</mediator>

<record>

<customerID>123857841</customerID>
<customername>Jand Doe</customername>
<customeraddress>

<street>123 Long Ave.</street>
<city>New York</city>
<state>NY</state>
<zip>12345-0000</zip>

</customeraddress>
<customercreditcardnumber>www.policysite.org/12568.pol,MTM0VF
9F5E$R96%K#$PCP3$QCP04T#2T</customercreditcardnumber>
<customercountry>USA</customercountry>
<customerflightpref>Window,Vegetarian</customerflightpref>
<customerdatausage>Y</customerdatausage>
<customersex>F</customersex>

</record>

</extracteddata>

The field privacymanager defines the IP address to be used to contact the privacy manager responsible for controlling access to obfuscated data. The mediator field points to a location where a Java application that functions as a private data mediating system can be downloaded. The customercreditcard field is obfuscated in the manner described above and includes the obfuscated data preceded by a URL to the policy held on a web server.

The data structure can be transmitted to other parties such that the entity that accesses the private data can be different to, and possibly in an organization remote from, the entity that retrieved it.

The representation of data via an explicit XML-based data structure allows a “transportable” representation: this can include data in clear, obfuscated data and the associated privacy policies. This data structure can be transmitted to other parties where private data may only be made intelligible via the mediation of a private data mediating system (if the associated privacy policies are satisfied). The XML data structure may include a URL or other instructions detailing where a version of the private data mediating system can be obtained to address the eventuality that the receiving system does not include this functionality. For example, the private data mediating system could be a Java applet that can be downloaded over the web, as illustrated above.

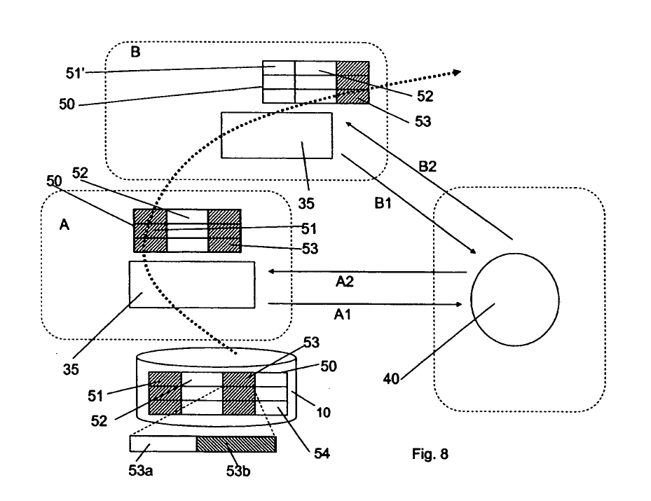

FIG. 7 is a schematic diagram showing selected aspects of the private data mediating system 35 and the privacy manager 40 in more detail. Note that there is no significance in the position, shape or orientation of the respective components illustrated.

The private data mediating system 35 is preferably an extension of traditional data repository's API 30 used by users 200 and applications 210 to access the data repository 10. The API 30 includes functionality to pass or retrieve data along with privacy policies and the declared intention (i.e. the reason for making this request) to a designated privacy manager 40. Note however, this extension does not require changes to the data repository 10 itself.

In case of access to a relational database, two basic interactions can happen:
Storage and update of private data: in addition to traditional INSERT or UPDATE SQL commands, the API allows users to specify the association of privacy policies to the data;
Retrieval of private data: traditional SELECT queries can be submitted to the database via the API. The private data mediating system 35 intercepts these queries and interacts with the privacy manager 40 to de-obfuscate data where needed. The actual de-obfuscation will depend on the current context, the user's credentials and privacy policies associated with the private data. The answer to the query could be provided either via a traditional database result set (where part of the data could be obfuscated) or via an explicit data structure based, for example, on the XML format.

The private data mediating system 35 may also include:
Data management module 220: the component in charge of formatting data in a proper way, depending on the underlying data repository and the requested privacy policies. This component provides a data “translation” service;
Policy handler module 230: an interpreter of privacy policies. This component interacts with the Privacy manager and ensures that the right information is provided to this service in order to obtain the de-obfuscation keys. It can be built in a way that the communication with the Privacy manager is optimized i.e. it happens only when it know it can satisfy the relevant privacy policies;
Obfuscation/Deobfuscation modules 240, 250: these modules are in charge of dealing with the encryption and decryption of private data, as described above;
Communication module 260: this module enables secure communication with the Privacy manager 40.

The Privacy manager 40 is responsible for enforcing privacy policies associated with private data. As discussed above, private data can be retrieved by entities and applications in an obfuscated form without satisfying the privacy policy. However, access to the de-obfuscated data is subject to satisfying the privacy manager that the associated policy is satisfied.

The privacy manager 40 verifies that privacy policies are fulfilled before providing the keys for de-obfuscating private data. Any disclosure of keys is preferably audited and monitored.

The privacy manager preferably includes:
Communication module 270: this module enables secure communication with the private data mediating system 35 and any other parties;
Authentication module 280: this module deals with requestor authentication when required by a privacy policy;
Credential verification service 290: this module deals with verification of the integrity and validity of digital credentials, i.e. certified information (including identity and attribute credentials);
Context management module 300: this module deals with storage, retrieval and processing of contextual information, relative both to specific interactions and the general situation;
Sensors 310: sensors can be used by the privacy manager to gather additional up-to-date contextual information. For example, a sensor might deal with the gathering of trust measures from Trusted Computing Group (TCG) enabled platforms. In such an example, privacy policies might dictate that private data can only be accessed and manipulated by TCG platforms. Add-ins can be deployed in the privacy manager to extend the privacy enforcement mechanisms.
Disclosure management module 320: this module deals with disclosure of decryption keys. The module interacts with the privacy policy engine to get the authorization to do this, once all the privacy policies are satisfied;
Privacy policy engine 330: this module interprets privacy policies. The interpretation process drives its interaction with the requesting private data mediating system, sensors and the disclosure management module. the privacy policy engine 330 may also be arranged to apply organization-wide policies to all requests, the organization-wide policies being stored in a database 335;
Audit 340: this module logs all the interactions happening with requestors to an audit log database 345, in particular related to the disclosure of decryption keys. The audit log should preferaly be tamper evident. Collecting auditing information is important to enforce accountability and ensure that, in case of privacy violations, forensic analysis can be done.

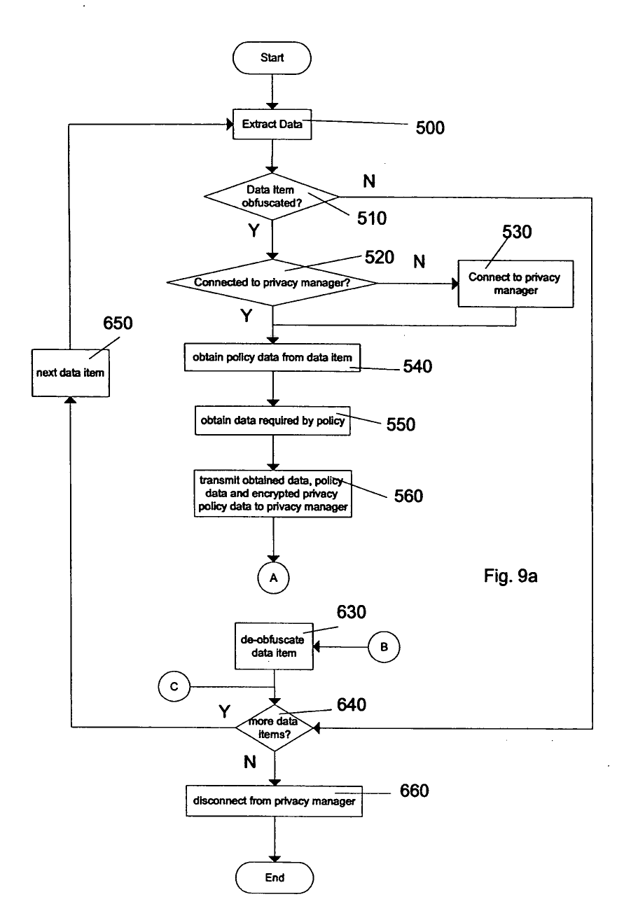

It will be appreciated that in embodiments of the present invention, the content of obfuscated data can be incrementally de-obfuscated, at different stages, by providing the privacy manager 40 with the required information (additional credentials, etc.). An example of this step-wise de-obfuscation is shown in FIG. 8, the dotted arrow showing the movement of data from the data repository 10 to a first requestor A and on to a second requestor B.

Requestor A interacts with its private data mediating system 35 to extract data from the table 50 of data repository 10. The data extracted is rows 51, 52 and 53, of which rows 51 and 53 are obfuscated. The data mediating system 35 transmits the policy data associated with each obfuscated row 51, 53 in message A1 to the privacy manager 40 along with any credentials or other data required to satisfy the policies. In this case, requester A does not satisfy the policy requirements for either of the obfuscated rows and the privacy manager sends message A2 declining to issue de-obfuscation data. Thus, the view of the extracted data available to requestor A merely consists of row 52 with rows 51 and 53 remaining unintelligible.

Requestor A then passes the extracted data to requestor B. Upon receipt, requestor B's private data mediating system 35 identifies that rows 51 and 53 are obfuscated and attempts to de-obfuscate them by transmitting the associated policy data along with necessary credentials etc in message B1 to the privacy manager 40. Upon receipt, the privacy manager 40 determines that requestor B satisfies the policy for row 51 but not for row 53. The privacy manager 40 therefore issues de-obfuscation data for row 51 in message B 2, allowing the private data mediating system 35 to de-obfuscate row 51 into intelligible data, shown in the Figure as 51′. Data in row 53 remains obfuscated. Requestor B's view of the data could be subsequently passed on to another requestor who may satisfy the policy requirements for row 53.

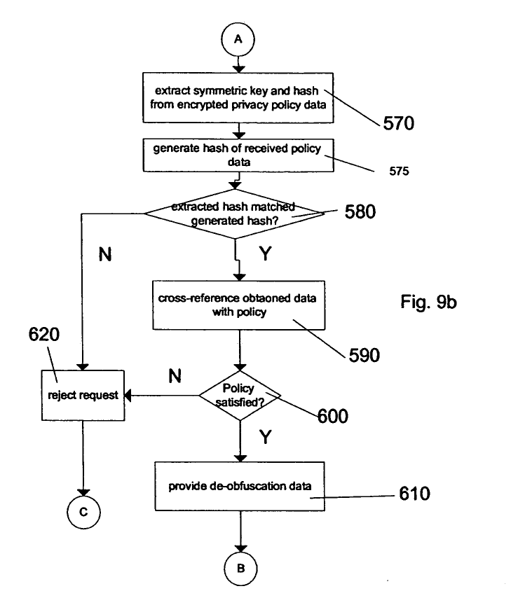

FIGS. 9a and 9b are flow diagrams illustrating the steps performed by a private data mediating system and a privacy manager, respectively, to determine whether a requestor satisfies the requirements of a policy.

In step 500, a requestor's private data mediating system extracts data from a repository. In steps 510 to 650, each extracted data item (field, record or the like) is processed by the private data mediating system. In step 510 the data item is checked to see if it is obfuscated. If the data item is not obfuscated then processing proceeds to the next item (if there is one) in steps 640 and 650.

If the data item is obfuscated, the private data mediating system checks for a connection to the privacy manager in step 520. If there is no connection then a secure connection is established with the privacy manager in step 530. The private data mediating system then obtains the policy data from the obfuscated data item in step 540 and obtains any data (such as data on the requester, the requestor's computer system, context and/or purpose of the request etc.) required to be submitted for fulfilment of the policy in step 550. the obtained data, the policy data and the encrypted privacy policy data is then transmitted to the privacy manager in step 560.

Upon receipt of the obtained data, the policy data and the encrypted privacy policy data, the privacy manager extracts the symmetric key and hash from the encrypted privacy policy data in step 570, generates a hash of the received policy data in step 575 and compares the extracted hash to the generated has in step 580 to determine if the received policy data has been altered or tampered with (for example if the policy has been modified). If the integrity check on the policy data fails then a rejection message is returned to the private data mediating system in step 620. If the integrity check on the policy data is passed then the data provided on the requestor etc is checked against the policy in steps 590 and 600. If the policy is satisfied then the privacy manager provides the private data mediating system with the extracted symmetric key for de-obfuscating the private data in step 610, otherwise a rejection message is sent in step 620.

Upon receipt of the symmetric key, the private data mediating system de-obfuscates the obfuscated private data in step 630. If more data items exist then these are processed, otherwise, any connections to the privacy manager are terminated in step 660.

Depending on the privacy policy and other requirements of the organization/enterprise, restrictions may be put in place via the private data mediating systems and/or at data gateways such as email servers, web servers, firewalls and the like requiring that policies be re-validated before data is transmitted. In this manner, a user may be given permission to view private data but would be restricted from onward transmission of the de-obfuscated data to some or all recipients. For example, the private data mediating system could be arranged to re-obfuscate private data (with the same or a new symmetric key) upon saving or copying the data. Similarly, a process or system at data gateways could scan for policy data and re-submit the policy data to the privacy manager 40 prior to transmission. In some contexts, the policy may allow de-obfuscated data to be transmitted but in others, transmission of the data in any form may be prohibited or transmission of the data in de-obfuscated form may be prohibited. As with the policy discussion above, any number of different restrictions could be set depending on the recipient, requestor, context etc.

It will be appreciated that the disclosure process for de-obfuscation data is adaptive and driven both by privacy policies and contextual information. Contextual information can be very rich, including not only users' credentials and declared intents, but also system information, measures of trust of the requestors' platforms, historical information, etc. It is important to notice that the disclosure of confidential information can modify the current context and, as a consequence, enable/disable sets of privacy policies and influence future disclosures.

The privacy manager can be deployed as a server, computer system or software application such as a service running on a server or computer system. The privacy manager may be located either remotely or locally to the site where the data repository is located. It could also be provided by a trusted third party to enable multi-party interactions and ensure a consistent enforcement of privacy policies.

In a more advanced scenario, privacy policies can ask the private data mediating system to interact with multiple privacy managers (each having specific competences) in order to access obfuscated data.

Embodiments of the data privacy management system and method of the present invention can potentially be bypassed as requestors could try to access data by directly querying the data repositories or by accessing the content of files (if they have the basic access control rights). However, in this case, any obfuscated data is unintelligible. This forces the requestor to interact with the privacy manager as dictated by the associated privacy policies.

Lifecycle management of privacy policies associated to private data, including their renewal and modification can be implemented in embodiments of the present invention. The management of keys is strictly related to the management of policies as decryption keys will be issued based on policy fulfillment. By changing a policy, the associated encryption key could automatically be changed. Revocation of keys and one-time usage of keys could also be addressed in this context.

Encryption keys could also be changed upon successful disclosure of private data. This could be done via a combined interaction between the privacy manager and the private data mediating system. At disclosure time the privacy manager asks the private data mediating system to change the encryption keys related to the following disclosure. Example scenarios where an encryption key may be changed include:
after the initial access to the data, the recipient can re-encrypt the data with a different key (and possibly subject to different policies) before sending the new data on;
if de-obfuscation keys are becoming insecure or out of date, the data owner or data repository administrator may need to update the database entries; or
the recipient wraps another layer (e.g. adds extra policies) before sending the data on to a third party.

It will be appreciated that it is preferable in the medium to long term for applications and services to be modified to be privacy-aware and to fully leverage embodiments of the data privacy management method and system of the present invention. This is particularly important for the storage of private data via the private data mediating system, as only in this way will data be stored according to privacy criteria (e.g. data obfuscation). However, it will also be appreciated that no immediate changes are needed to legacy applications and systems upon implementation of an embodiment according to the present invention. Indeed, even the obfuscation of private data and the addition of privacy policies could be implemented over time given that the approach taken by embodiments according to the present invention is complementary to and compatible with existing data repositories.

While the above embodiments have shown policies applied to whole rows of data, it will be appreciated that policies could be applied to particular data fields or records. In addition, more than one policy could apply to a data item —there may be a policy associated with the particular item, another associated with the whole record and perhaps another associated with the organization itself. In such situations, a hierarchy would have to be defined to avoid one policy conflicting with another. Most likely the policy associated with the data item would take precedence followed by that for the record followed by that for the organization.

Compared with traditional “views” on data (for example views on database tables), embodiments of the present invention reduce the need for defining a broad set views to accommodate multiple different cases. Depending on requesters' capabilities and clearance, access and privacy constraints are directly associated with data and dictate what can be seen at any point in time.

Privacy policies are strongly associated to data at least until the first disclosure happens. Disclosures are preferably audited along with the context in which the disclosure happened. Audit logs increase the accountability of the involved entities and can be used for forensic analysis in case of detected privacy violations. In the future, it is likely that further controls will be available: most notably, if the requestor's platform includes technologies such as security-enhanced operating systems (OS) and TCG technology, these could potentially be used to control the use and propogation of deobfuscated data, for example by OS-level checking over whether certain operations are allowed on specific (tagged) data and hardware-based control over the use of the data (such as only allowing it to be accessed within a trustworthy software state).

While embodiments of the present invention have been shown using relational databases as reporsitories (in particular SQL databases), it will be appreciated that embodiments of the present invention are applicable to any form Of data reporsitory, whether in the form of a database, file system or other system.

1. A data privacy management system comprising a data repository, a private data mediating system and a privacy manager,
the data repository storing private data items in an obfuscated form, each private data item having associated privacy policy data defining conditions to be met to ensure the privacy of the data item;
the private data mediating system being arranged to communicate with the privacy manager for obtaining de-obfuscated private data items extracted from the data repository;
wherein de-obfuscation of the data is subject to satisfaction of the privacy manager that the respective conditions ensuring privacy of the data item are met.

2. A data privacy management system as claimed in claim 1, wherein the associated privacy policy data is stored with the private data item in obfuscated form.

3. A data privacy management system as claimed in claim 2, wherein de-obfuscation of the data is dependent on a function performed on the associated privacy policy data.

4. A data privacy management system as claimed in claim 2, wherein the associated privacy policy data comprises a pointer to said conditions.

5. A data privacy management system as claimed in claim 4, wherein the pointer is a unique resource locator, URL.

6. A data privacy management system as claimed in claim 2, wherein the associated privacy policy data comprises data encoding said conditions.

7. A data privacy management system as claimed in claim 6, further comprising a policy management system operative to provide said conditions or data on said conditions upon presentation of the data encoding said conditions.

8. A data privacy management system as claimed in claim 7, wherein the privacy manager includes the policy management system.

9. A data privacy management system as claimed in claim 2, wherein the obfuscated form of a private data item includes obfuscated privacy policy data, wherein the privacy manager is arranged to check the integrity of the associated privacy policy data in dependence on the obfuscated privacy policy data, de-obfuscation being dependent on the integrity of the associated privacy policy.

10. A data privacy management system as claimed in claim 1, wherein the obfuscation comprises encryption, wherein, when satisfied that the respective conditions ensuring privacy of the data item are met, the privacy manager is operative to provide data for decrypting the obfuscated data to the private data mediating system.

11. A data privacy management system as claimed in claim 1, wherein the obfuscation comprises hashing, the data privacy management system further comprising a further data repository storing the private data items in non-hashed form, the further data repository being accessible by the privacy manager, wherein, when satisfied that the respective conditions ensuring privacy of the data item are met, the privacy manager is operative to provide the non-hashed private data item from the further data repository to the private data mediating system.

12. A data privacy management system as claimed in claim 1, wherein the private data mediating system is arranged to generate a data file storing one or more selected de-obfuscated private date items and/or obfuscated private data items for onward transmission.

13. A data privacy management system as claimed in claim 12, wherein de-obfuscated private data items are stored subject to satisfaction of the privacy manager that the respective conditions ensuring privacy of the data item are met.

14. A data privacy management system as claimed in claim 1, further comprising a data gateway arranged to identify private data items extracted from said repository and permit passage of said private data items through the data gateway upon satisfaction of the privacy manager that the respective conditions ensuring privacy of the data item are met.

15. A data privacy management system as claimed in claim 14, wherein the data gateway is arranged to identify permit passage of de-obfuscated private data items through the data gateway upon satisfaction of the privacy manager that the respective conditions ensuring privacy of the data item are met.

16. A data privacy management system as claimed in claim 14, wherein the data gateway is arranged to obfuscate private data items passing through the data gateway in dependence on the respective conditions ensuring privacy of the data item.

17. A data privacy management system as claimed in claim 14, wherein the data gateway comprises an email server.

18. A data privacy management system as claimed in claim 1, wherein the private data item stored in an obfuscated form includes a record having a plurality of data fields.

19. A data privacy management system as claimed in claim 18, wherein one or more of the data fields is stored in an obfuscated form, the one or more data fields having associated privacy policy data defining conditions to be met to ensure the privacy of the data field, wherein de-obfuscation of the data field is subject to satisfaction of the privacy manager that the respective conditions ensuring privacy of the data item and the data field are met.

20. A database system for managing data privacy comprising a database, a database application protocol interface and a data management system;
the database including obfuscated private data items stored with privacy policy data associated with conditions to ensure the privacy of the data item;
the database application protocol interface including computer readable program code means for
extracting privacy policy data with any obfuscated private data items extracted from the database;
obtaining data required by said privacy policy for disclosure of an extracted private data item; and,
communicating said obtained data and said extracted privacy policy data to the data management system to de-obfuscate extracted private data items;
wherein, upon receipt of said obtained data and said extracted privacy policy, the data management system is arranged to provide data for de-obfuscating the obfuscated private data item if the respective conditions associated with the privacy policy data are met by the obtained data.

21. A data structure including a plurality of obfuscated private data items and privacy policy data associated with each obfuscated private data item, the privacy policy data being associated with conditions to be met to for disclosure of the private data item in a de-obfuscated form, wherein upon the conditions being met, the data structure being arranged to store the private data item in the de-obfuscated form for onward communication, the private data items being selectively de-obfuscated upon the respective conditions being met enabling onward communication of the data structure including obfuscated and de-obfuscated data items.

22. A method of managing privacy of a data item comprising:
associating privacy policy data with the data item, the privacy policy data defining conditions to be met to ensure privacy of the data item;
obfuscating the data item;
storing the obfuscated data item and privacy policy data in a data repository;
accepting a request by a requestor to de-obfuscate the obfuscated data item obtained from the data repository, the request including the privacy policy data; and,
transmitting data for de-obfuscating the obfuscated data item to the requestor if the conditions defined by the privacy policy data are met.

23. A method as claimed in claim 22, further comprising storing the associated privacy policy data with the private data item in obfuscated form.

24. A method as claimed in claim 23, wherein the step of transmitting data for de-obfuscating of the data is performed only if a function performed on the associated privacy policy data is successful.

25. A method as claimed in claim 22, further comprising:
providing said conditions or data on said conditions upon presentation of data encoding said conditions.

26. A method as claimed in claim 22, wherein the obfuscated form of a private data item includes obfuscated privacy policy data, the method further comprising a step of checking the integrity of the associated privacy policy data in dependence on the obfuscated privacy policy data, the step of transmitting being dependent on the step of checking the integrity of the associated privacy policy.

27. A method as claimed in claim 22, wherein the step of obfuscating includes encryption, wherein the step of transmitting includes transmitting data for decrypting the obfuscated data.

28. A method as claimed in claim 22, wherein the step of obfuscating includes hashing, wherein the step of transmitting includes:
obtaining a copy of the non-hashed private data item from a further data repository; and,
transmitting the non-hashed private data item to the requestor.

29. A method as claimed in claim 22, further comprising:
generating a data file storing one or more selected de-obfuscated private date items and/or obfuscated private data items for onward transmission.

30. A computer readable medium having computer readable code means embodied therein for managing privacy of data items and comprising:
computer readable code means for associating privacy policy data with a data item, the privacy policy data defining conditions to be met to ensure privacy of the data item;
computer readable code means for obfuscating the data item;
computer readable code means for storing the obfuscated data item and privacy policy data in a data repository;
computer readable code means for accepting a request by a requestor to de-obfuscate the obfuscated data item obtained from the data repository, the request including the privacy policy data; and,
computer readable code means for transmitting data for de-obfuscating the obfuscated data item to the requestor if the conditions defined by the privacy policy data are met.

31. A computer readable medium as claimed in claim 30, further comprising computer readable code means for storing the associated privacy policy data with the private data item in obfuscated form.

32. A computer readable medium as claimed in claim 30, further comprising:
computer readable code means for providing said conditions or data on said conditions upon presentation of data encoding said conditions.

33. A computer readable medium as claimed in claim 30, wherein the means for obfuscating includes means for encrypting, wherein the means ofr transmitting includes means for transmitting data for decrypting the obfuscated data.

34. A computer readable medium as claimed in claim 30, wherein the means for obfuscating includes means for hashing, wherein the means for transmitting includes:
computer readable code means for obtaining a copy of the non-hashed private data item from a further data repository; and,
computer readable code means for transmitting the non-hashed private data item to the requestor.

35. A computer readable medium as claimed in claim 30, further comprising:
computer readable code means for generating a data file storing one or more selected de-obfuscated private date items and/or obfuscated private data items for onward transmission.

36. A data privacy management system comprising a data repository, a private data mediating system and a privacy manager;
the data repository storing private data items in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met.

37. A data privacy management system comprising a data repository, a further data repository, a private data mediating system and a privacy manager;
the data repository storing private data items in a hashed form, each private data item having associated privacy policy data defining conditions to be met to ensure the privacy of the data item;
the private data mediating system being arranged to communicate with the privacy manager for obtaining non-hashed private data items extracted from the data repository;
the further data repository storing private data items in a non-hashed form, data from said further data repository being accessible subject to satisfaction of the privacy manager that the respective conditions ensuring privacy of the data item are met.

38. A data privacy management system comprising a data repository, a private data mediating system and a privacy manager;
the data repository storing private data items in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met, the private data mediating system being arranged to generate a data file storing one or more selected de-obfuscated private date items and/or obfuscated private data items for onward transmission.

39. A data privacy management system comprising a data repository, a private data mediating system, a data gateway and a privacy manager;
the data repository storing private data items in an encrypted form, each private data item having associated privacy policy data defining conditions to be met to ensure the privacy of the data item;
the private data mediating system being arranged to communicate with the privacy manager for obtaining decrypted private data items extracted from the data repository;
wherein decryption of the data is subject to satisfaction of the privacy manager that the respective conditions ensuring privacy of the data item are met, the data gateway being arranged to identify de-obfuscated private data items extracted from said repository and permit passage of said private data items through the data gateway upon satisfaction of the privacy manager that the respective conditions ensuring privacy of the data item are met.

40. A data privacy management system as claimed in claim 39, wherein the data gateway is arranged to obfuscate private data items passing through the data gateway in dependence on the respective conditions ensuring privacy of the data item.
